(19) United States
(12) Patent Application Publication
(10) Pub. No.: US 2014/0016966 A1
(43) Pub. Date: Jan. 16, 2014

(54) Digital Printing Apparatus and Digital Printing Process

(71) Applicant: Xeikon IP BV, Eede (NL)

(72) Inventors: Jürgen Norbert Bart Devlieghere, Borgerhout (BE); Lode Erik Dries Deprez, Wachtebeke (BE); Nick Horemans, Noorderwijk (BE); William Constant Maria Waterschoot, Belsele (BE)

(21) Appl. No.: 13/938,152

(22) Filed: Jul. 9, 2013

(30) Foreign Application Priority Data
Jul. 10, 2012 (EP) 12175762.9
Apr. 5, 2013 (EP) 13162556.8

(51) Int. Cl. G03G 15/10

(52) U.S. Cl. CPC G03G 15/11
USPC 399/249

(57) ABSTRACT

A digital printing apparatus using liquid toner comprising chargeable imaging particles and carrier liquid, comprising an imaging member (140) to sustain a pattern of electric charge forming a latent image on its surface, a development member (130) to receive toner (100) from a reservoir (110), and to develop the image by transferring toner onto the imaging member (140) in accordance with the pattern, leaving a remaining fraction of the toner on the development member (130), an electrical field generating means to compact the particles by applying a field before transfer onto the imaging member (140), means (150, 160) for depositing the toner onto a substrate (199), and means (133) for removing remaining toner from the development member (130), comprising an integrated source for generating an oscillating electric field, arranged to decompactify the chargeable imaging particles and mechanical removal means for removing the liquid toner.

### RELATED APPLICATIONS

The present application claims priority to European patent application no. 12 175 762.9 filed Jul. 10, 2012, and European patent application no. 13 162 556.8 filed Apr. 5, 2013, the disclosures of each of which are incorporated herein by reference for all purposes.

### BACKGROUND

The present disclosure relates to a digital printing apparatus using liquid toner comprising chargeable imaging particles and a carrier liquid, in particular according to the preamble of claim 1.

An apparatus and process as described above is known from US patent application publication no. 2009/0052948.

The efficiency of removal of unused liquid toner from the development member in the known apparatus is limited, because the imaging particles in the liquid toner tend to coagulate and stick to the development member. In addition, the proposed removal means are mechanically complex and prone to wear.

It is therefore a purpose of the present disclosure to provide a digital printing apparatus and process using liquid toner, in particular high-viscosity toner, that overcomes some or all of the above mentioned disadvantages.

This purpose is achieved by an embodiment of the disclosure comprising a first member arranged to receive and transport a quantity of liquid toner and excess removal means arranged to remove liquid toner containing charged particles from said first member. The excess removal means comprise mechanical removal means for mechanically removing said liquid toner from said first member, and a source for generating an AC electric field in the liquid toner containing charged particles. The source comprises a stationary electrode placed in proximity of the first member, said source with electrode being arranged to substantially decompactify said chargeable imaging particles prior to or during said mechanical removal.

The advantage of using a stationary electrode compared with charge/discharge rollers is that a stationary electrode does not suffer from cleaning problems and can be more easily integrated with other components.

The electrode may be integrated in the mechanical removal means. According to an embodiment, the excess removal means comprise a scraper in contact with the first member, and the electrode is integrated in the scraper. In that way a very compact and efficient excess cleaning means is achieved.

The electrode may e.g. be a wire, a plate, or a combination thereof. The electrode is typically located at a distance between 5 and 1000 μm from the surface of the first member.

### SUMMARY

In embodiments of the disclosure, the electrode is incorporated in electrically insulating material, such that a layer of electrically insulating material extends between a surface of the first member and the electrode.

According to an advantageous embodiment, the excess removal means comprise a discharge blade in contact with the first member, and the electrode is integrated in the discharge blade such that a layer of electrically insulating material is formed between the first member and the electrode. The shape and material of the discharge blade are preferably such that a good contact is achieved over a sufficiently large surface. Such an embodiment has the advantage that an AC electric field may be applied over an extended length seen in the process direction, prior to mechanical removal. In that way the charged imaging particles can be subjected to a sufficient number of alternations of the AC signal, such that a good decompacting is achieved.

According to another advantageous embodiment, the stationary electrode is arranged opposite to a surface of the first member, such that a channel for liquid toner is created between the electrode and the first member. The excess removal means may then further comprise liquid injection means configured for injecting liquid in the channel, in order to further enhance the decompacting and cleaning performance. The injected liquid can be e.g. toner liquid or carrier liquid, depending on the location in the process where the removal means are added.

According to another aspect of the disclosure the electrode has an electrode surface opposite to a surface of the first member. The electrode surface extends substantially parallel to the surface of the first member, preferably over a length, seen in the process direction, which is larger than 5 mm, more preferably larger than 10 mm.

Typically the first member is a rotating roller, but the first member could also be a rotating belt.

The apparatus preferably comprises biasing means setting a DC bias between the first member and the electrode having an absolute value between 0 and 1 kV. The source for generating an AC electric field is preferably configured for applying an AC voltage on the electrode having an oscillating component with an amplitude in the range of 500 V rms to 5000 V rms and a frequency in the range of 0.5 kHz to 5 kHz. For embodiments using positively charged particles, the DC bias voltage could be e.g. have a value V1 between 0 and 650 V for the first member and a value V2 between −100 V and 650 V for the electrode, wherein V2 is typically smaller than V1. However, it is noted that the charging and discharging behavior is typically not symmetrical and that an AC bias without DC bias may have an overall discharging (erasing) effect sufficient for obtaining a good decompacting behavior.

The source for generating the AC electric field may comprise an open- or closed-loop control system as disclosed in patent application with application number NL 2010573 in the name of the Applicant, filed on 5 Apr. 2013. The content of this application is included herein by reference.

The purpose of another embodiment of the disclosure is achieved by a digital printing apparatus of the aforementioned kind, wherein the excess removal means further comprises an integrated source for generating an oscillating electric field arranged to substantially decompactify said chargeable imaging particles prior to or during said mechanical removal.

It is an advantage of the apparatus of the present disclosure that the toner particles are electrophoretically brought into vibration, such that any coagulation that may have taken place is reversed to an extent that renders subsequent removal of the liquid toner more effective.

In an embodiment the apparatus may comprise an imaging member adapted to sustain a pattern of electric charge forming a latent image on its surface; a development member arranged to receive a quantity of liquid toner from a reservoir, and to develop the latent image by transferring a portion of the quantity of liquid toner onto the imaging member in accordance with the pattern, the developing leaving a remaining fraction of the quantity of liquid toner on the development member; an electrical field generating means adapted to compact the chargeable imaging particles in the quantity of liquid toner by applying an electric field prior to its transfer onto the imaging member; excess removal means arranged to remove the remaining fraction from the development member; and depositing means arranged to deposit the transferred portion (i.e., the developed image) onto a printing substrate; wherein the excess removal means comprises mechanical removal means for mechanically removing the liquid toner from the development member. The present disclosure also pertains to a corresponding printing process. The electrical field generating means may be further adapted to charge said chargeable imaging particles.

It is an advantage of this embodiment that it removes or reduces the need to pre-charge the imaging particles, prior to supplying them to the printing apparatus as a component of the liquid toner suspension.

In an embodiment of the apparatus according to the present disclosure, the oscillating electric field source is an elongate electrode arranged parallel to and in proximity of the development member.

It is an advantage of this embodiment that the potential of the development member need not be varied. Thus, the development member, which is typically a rotating roll, may be kept at the potential which is most suitable for affecting the transfer of toner particles from the development member to the imaging member, while an external electrode provides the electric field variation that loosens the suspended toner particles.

In another particular embodiment, the electrode comprises a sheet or comb shaped member arranged to be at least partly immersed in the liquid toner adhering to the development member.

It is an advantage of this embodiment that the electrode acts upon the suspended toner particles in both an electrophoretical and a mechanical way, thus rendering the toner removal process more effective.

In an embodiment of the apparatus according to the present disclosure, the electrical field source carries a bias voltage in the range of −300 V to −100 V.

The use of a bias voltage has the advantage that the freely suspended, positively charged toner particles can be made to drift towards the intended evacuation zone under the influence of the average electric field. It has been found that a bias voltage in the cited range provides the most effective removal of toner.

In an embodiment of the apparatus according to the present disclosure, the electrical field source carries an oscillating component with an amplitude in the range of 4000 V rms to 5000 V rms.

It has been found that a high-frequency component in the cited range provides a good trade-off between energy consumption and effectiveness of the removal process. In particular, good results have been obtained with a voltage of approximately 4300 V rms.

In an embodiment of the apparatus according to the present disclosure, the oscillating electric field has a frequency in the range of below 5 kHz, e.g. between 50 Hz to 1500 Hz. More preferably the frequency is between 0.5 kHz and 5 kHz.

Higher frequencies, for instance frequencies between 800 Hz and 1500 Hz, may require additional conversion steps, but have also been shown to produce good removal results. A frequency of approximately 1000 Hz is preferred.

The cited frequency range is believed to include a resonance frequency for the oscillatory movement of suspended toner particles in the carrier liquid.

In an embodiment, the apparatus according to the present disclosure further comprises a fusing station, adapted to fuse the deposited portion of liquid toner onto the substrate. In a particular embodiment, the fusing station is adapted to apply one of heat, pressure, and UV illumination to the printed substrate.

In an embodiment of the apparatus according to the present disclosure, the liquid toner reservoir is a replaceable liquid toner tank.

In an aspect of the disclosure, there is provided a system comprising the digital printing apparatus described above and a liquid toner tank.

In an aspect of the disclosure, there is provided a digital printing process using liquid toner, the liquid toner comprising chargeable imaging particles and a carrier liquid, the method comprising: producing a latent image as a pattern of electric charge on an imaging member; transferring a quantity of liquid toner from a reservoir onto a development member; compacting the chargeable imaging particles in the quantity of liquid toner by applying an electric field; developing the latent image by transferring a portion of the quantity of liquid toner onto the imaging member in accordance with the pattern after the charging and compacting, said developing leaving a remaining fraction of the quantity of liquid toner on the development member; removing the remaining fraction from the development member; and depositing the portion onto a printing substrate; wherein the removing of the remaining fraction comprises mechanically removing the liquid toner from the development member using excess removal means; and wherein the removing of the remaining fraction further comprises applying an oscillating electric field to the remaining fraction so as to substantially decompactify the chargeable imaging particles prior to or during the mechanical removal, using means for generating the oscillating electric field that are integrated in the excess removal means.

In an embodiment of the process according to the present disclosure, the applying of the electrical field comprises charging an electrode in proximity of the development member with a bias voltage in the range of −300 V to −100 V.

In an embodiment of the process according to the present disclosure, the applying of the electrical field comprises charging an electrode in proximity of the development member with a high-frequency component with an amplitude in the range of 4000 V to 5000 V.

In an embodiment of the process according to the present disclosure, the electrical field has a frequency in the range of 0.5 kHz to 5 kHz.

The technical effects and advantages of the various embodiments of the process according to the present disclosure correspond mutatis mutandis to those described above in connection with the apparatus according to the disclosure.

### BRIEF DESCRIPTION OF THE DRAWINGS

These and other technical effects and advantages of embodiments of the disclosure will be described in more detail in connection with the accompanying figures, in which:

FIG. 1 presents a schematic diagram of an apparatus according to an embodiment of the present disclosure;

FIG. 2 presents a flow chart of an exemplary printing process according to an embodiment of the present disclosure;

FIG. 3 presents a more detailed illustration of a toner supply and removal arrangement as used in embodiments of the present disclosure;

FIG. 4 illustrates schematically an embodiment with discharge blade;

FIG. 5 illustrates schematically an embodiment with a flexible strip electrode integrated in a scraper;

FIG. 6 illustrates an embodiment with a wire electrode integrated in a scraper;

FIG. 7 illustrates an embodiment with a plate electrode integrated in a scraper; and

FIG. 8 illustrates an embodiment with an electrode and liquid injection means.

### DETAILED DESCRIPTION

Known xerography processes operate either with “dry toner” or “liquid toner”.

Dry toner consists of resin particles, having an average diameter of approximately 7-10 μm in most modern applications, which carry a small amount of pigmented substance, typically in the range of 2% to 10%. The resin may be a transparent polyester, a styrene acrylate copolymer, or another suitable polymer. The material properties of the beads make them prone to developing static electric charges, which allow them to be transported between different components of the printing system by the application of a suitable electric field.

In dry toner systems, the toner particles travel through an air gap. The spatial precision of the deposition of the dry toner particles is therefore limited by the influence of the centrifugal force on the particles, and by the mutual electric repulsion between the charged particles.

In liquid toner, the imaging particles or marking particles are supplied as solid particles suspended in a carrier liquid. The imaging particles consist of pigment grains, typically embedded in a small bead of resin, with an average diameter of for instance 2 μm. A dispergant is added to the mix to avoid clustering of the toner particles. In order for the suspended particles to be susceptible to acceleration under the effect of an electric field (electrophoresis), they must be capable of retaining an electrical charge. This charge may be attained by the particles as a result of charge exchange between the particles and molecules of the carrier liquid, or it may be induced by an externally applied electric field. The carrier liquid may comprise any suitable liquids as is known in the art, and may include silicone fluids, hydrocarbon liquids and vegetable oils, or any combinations thereof. The carrier liquid may further contain variable amounts of charge control agent (CCA), wax, plasticizers, and other additives.

In liquid toner systems, an amount of liquid toner or developer is applied from a photoelectric development member to the surface of an imaging member bearing a latent image in the form of an electrostatic pattern. In liquid toner systems, the particles only travel in the liquid phase, as it is practically not feasible to provide a sufficiently strong electric field to overcome the intermolecular forces that tend to keep the particles suspended in the liquid. Hence, there has to be a continuous presence of the liquid medium between the development member and the imaging member, to allow the toner particles to “swim” across. The distance to be bridged by the toner particles is in the order of 1 to 40 μm, typically approximately 5 μm.

In liquid toner of a known type, such as the one commercialized by Hewlett-Packard under the “Indigo” and “ElectroInk” brands, the suspended particles carry a natural electric charge due to the physical and chemical properties of the liquid and the particles. This charge allows them to be transported between different components of the printing system by the application of a suitable electric field.

However, in order to provide the aforementioned natural charge, and in order to allow easy removal of excess carrier liquid by evaporation, specific types of highly volatile liquids have been used that present certain environmental disadvantages.

It has therefore been proposed to use liquid toners in which the carrier liquid is non-volatile, and in which the toner particles are not necessarily naturally charged. An exemplary digital printing system using liquid toner is described in more detail in US patent application publication no. 2009/0052948, the content of which is incorporated into this application in its entirety by this reference.

Without loss of generality, any features described in the present application which are not specific to the present disclosure may be implemented in accordance with the examples and alternatives specified in the cited US patent application publication, or combined with same.

US 2009/0052948 is specifically concerned with highly concentrated liquid toner development systems (designated as “high viscosity” toner or HVT systems), used at high printing speeds, in particular, printing speeds of greater than 0.5 ms⁻¹.

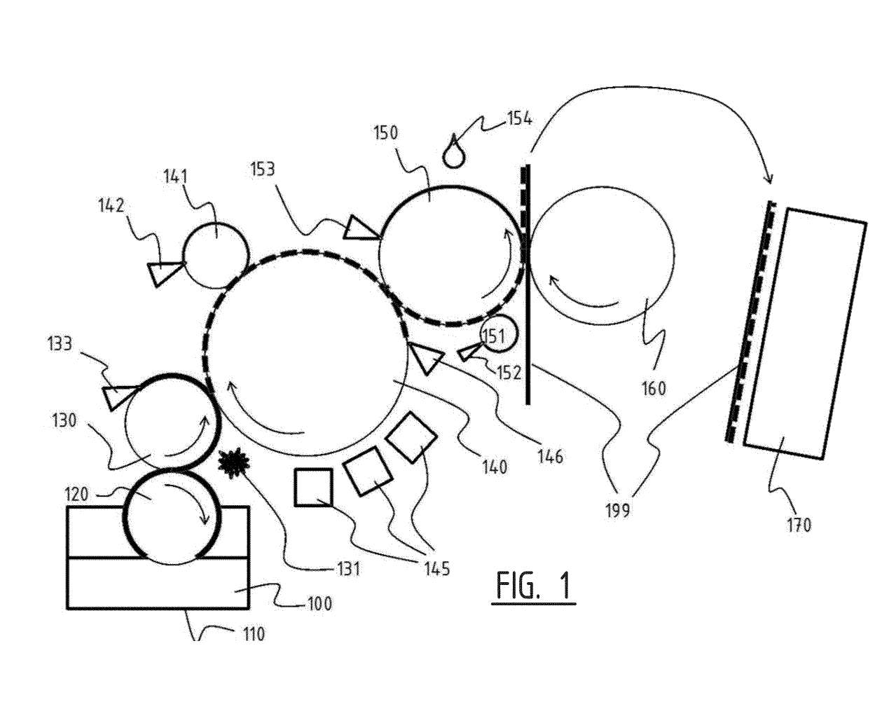

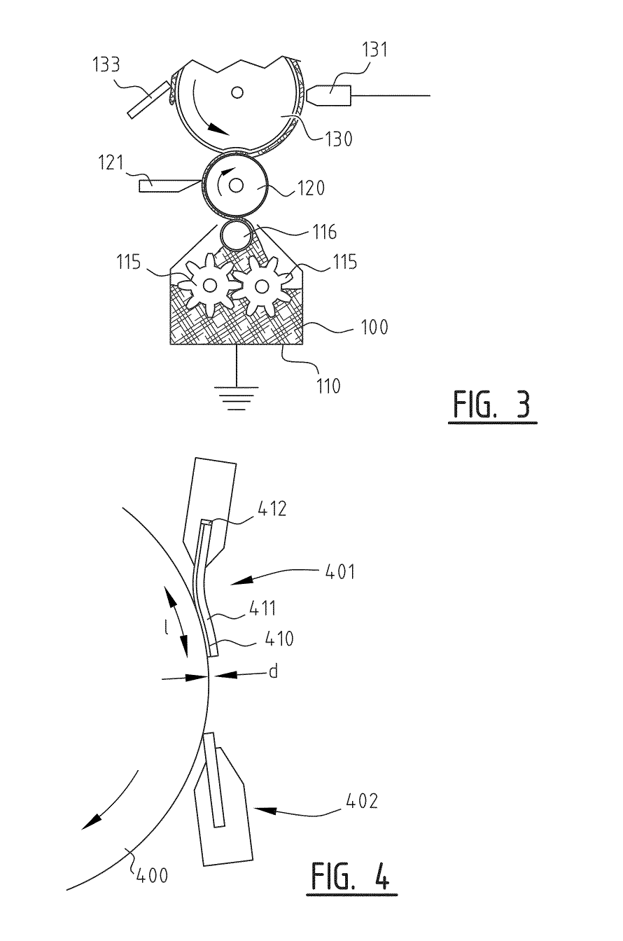

Similarly, the apparatus and process of the present disclosure preferably utilizes toner with solids concentrations between 5% and 50% by weight, preferably between 10% and 40%, and most preferably between 15% and 35%. The solid content is defined at the toner supply member (see Figure description below, element 120 in FIG. 1 or element 116 in FIG. 3). The high-shear viscosity, as measured at a shear rate of 3000 s⁻¹ at 25° C. with a cone plate geometry of C60/1° and a gap of 52 μm, is preferably in the range of 5-500 mPa·s.

Generally, the required concentration of solids in the liquid toner and the required degree of compactification will be a function of the width of the development gap, i.e., the distance between the development member and the imaging member. This gap has to be completely bridged by a liquid phase, to allow toner particles to migrate from the development member to the imaging member. The amount of liquid that is present between both members must contain a sufficient amount of pigmented particles to eventually obtain the desired pigment density on the substrate. Thus, generally speaking, a higher concentration of solid particles will be required for smaller development gaps, and therefore the resulting liquid toner will also tend to be more viscous.

To realize an efficient development, it is preferable that the parameter T=solid content [%]×toner layer thickness [μm] is in the range of 40-250. More preferably, T is in the range of 60-200, and most preferably it is between 80 and 150. The relevant toner layer thickness is determined at the moment of development (with reference to FIG. 1, described below, this is the layer thickness of the toner in the “gap” between the development member 130 and the imaging member 140).

It should be noted that the above mentioned development “gap” does not necessarily exist as an empty space between the development member and the imaging member which would subsequently be filled with liquid. Preferably, the development member and the imaging member run with an interference fit, i.e. they normally run in forced contact with each other, wherein the surface of the members is compressed to some extent in the contact zone. When the members are wetted by liquid toner, the liquid toner will tend to adhere to the surfaces even in the contact zone, where it will create the aforementioned development gap as a very thin layer of liquid phase between the compressed surfaces. To obtain this effect, the materials of the development member and the imaging member, or at least one of them, must be selected to exhibit sufficient elasticity and appropriate hardness. Hardness values in the range of 60-65 ShA have been shown to yield excellent results.

A digital printing system according to the present disclosure will now be described in connection with FIG. 1.

FIG. 1 schematically illustrates the application of an amount of toner 100, initially stored in a toner reservoir 110, via a toner supply member 120, a development member 130, an imaging member 140, and an optional intermediate member 150, to a substrate 199. Without loss of generality, the aforementioned members are all illustrated and described as rollers. The development member 130, imaging member 140, and intermediate member 150 all transfer part of the liquid toner 100 adhering to their surface to their successor; the part of the liquid toner 100 that remains present on the member's surface is removed after the transfer stage by appropriate means. These means are schematically illustrated as respective removal means 133, 146, 153. Excess carrier liquid present on the substrate 199 after printing is in part absorbed by the substrate 199, and may in part evaporate, depending on the type of substrate and the volatility of the carrier liquid, substantially during the substrate's stay in the fusing station 170; the remainder may be removed.

To facilitate removal of toner particles that may remain present on the surface of the intermediate member 150 after contact with the substrate 199, a small amount of carrier liquid or solvent 154 may be applied to the surface prior to its engagement with the removal means 153.

Film-like layers of liquid toner 100 as may be present on the various roller surfaces 120, 130 are shown in FIG. 1 as thick solid lines overlaid on the respective roller surfaces 120, 130. Where the toner 100 present on the respective roller surfaces 140, 150, or the substrate 199, represents a developed image, this is illustrated by a thick dashed line overlaid on the respective carrier. Where excess carrier liquid is removed from the main rollers 140, 150 by respective carrier liquid removal means 141-142 and 151-152, the film of carrier liquid is illustrated as a thinner solid line overlaid on the respective roller surface 141, 151. The skilled person shall appreciate that the “carrier liquid” as removed by the removal means 141-142 and 151-152 is preferably substantially free from toner particles, but that a full separation may be technically unfeasible.

As stated above, electrostatographic printing processes involve the creation of a visible image by the attraction of charged imaging particles or marking particles to charged sites present on a substrate. Such charged sites, forming a latent image, can be transiently supported on an imaging member 140 which may consist of photoconductors or pure dielectrics and may be rendered visible in situ or be transferred to another substrate to be developed in that location. The imaging member 140 is preferably a photoconductor roll, upon which the latent image is produced by selectively illuminating the roll with a sufficiently focused light source 145, such as a laser or LED array. In particular, the image forming stage may consist of providing a uniform electrostatic charge to the surface by means of a charging device, and selectively discharging the uniform electrostatic charge by illumination, to form the electrostatic latent image.

In the development stage, toner particles travel from a development member 130 supplied with a thin, film-like layer of liquid toner 100, onto the imaging member 140 that carries the latent image. As the developer roll 130 and the photoelectric roll 140 part ways, some liquid will remain as a film on the surface of each of the rolls, as a result of the adhesion forces.

To obtain an optimal printing resolution without background noise, it is essential that the liquid remaining on the photoelectric roll does not contain substantial amounts of free-roaming toner particles outside the developed areas. In addition, a top layer of the liquid phase that is substantially free from toner particles facilitates the mechanical removal of excess carrier liquid.

The electric force results from the electric field between the development roller (which is preferably set at a tension of approximately 400 V) and the photoconductor roller (which preferably presents electric potentials varying between 0 V and 600 V in different areas of the latent image).

In an optional subsequent step, the developed image is transferred from the photoconductor 140 onto an intermediate roller 150, which is preferably kept at a potential of approximately −200 V. An intermediate roller 150 with a sufficiently elastic surface, e.g. a surface made of hardened rubber or a suitable elastomer, may be used when the surface of the printing substrate is not perfectly smooth. This is the case when the printing substrate 199 is uncoated paper. The elasticity of the surface of the intermediate roller 150 will allow the deposition of an image with appropriate quality, thanks to the roller's ability to adapt to the unevenness of the substrate.

In the final transfer step, the developed image is transferred from the intermediate roller 150 (or from the photoconductor 140, if no intermediate roller is used), onto the substrate 199, which is preferably supported by a 2^{nd} transfer roller 160 that is kept at a more negative potential, preferably at or around −1200 V.

The development member 130 may be supplied with liquid toner from a reservoir 110 via a toner supply roller 120 and a metering roller (not illustrated), with a pick-up roller and/or a feeder roller optionally arranged between them (not illustrated). The reservoir 110 may be connected to or include a replaceable liquid toner tank. The metering roller may comprise a pattern of recesses and may be equipped with a doctor blade bearing against its surface in order to guarantee the uptake of liquid toner at a substantially fixed rate, as may be appropriate for the desired printing speed.

Preferably, a carrier liquid displacement device is provided, which may take various forms, including the form of a corona generating device 131 or the like, or it may take the form of a roller type mechanism. The carrier liquid displacement device is placed upstream of the interface with the imaging member 140, in a position adjacent to the development member 130, and a corona producing voltage, in the case where a corona generating device 131 is used, is applied to establish an electric field across the toner layer and, through electrophoretic movement of the charged toner particles, creates a spatial separation of the toner particles and the carrier liquid within the toner deposit, whereby the carrier liquid is displaced to the surface of the toner layer, and therefore, if required, acts as a pre-wet layer.

Another effect of the carrier liquid displacement device is to supply, adjust, or reinforce the charge on the individual toner particles and provide additional particle compaction for enhanced density uniformity of the developed image.

Hence, in appropriately composed suspensions, the imaging particles can at once be charged and locally concentrated or compacted by the application of a suitable electric field. The toner particles may be concentrated in a zone facing away from the liquid/air interface.

The carrier liquid displacement device preferably comprises a corona discharge device 131. The voltage applied to the corona discharge device being of a sufficient order to create a corona discharge. The charging and compactification of the toner particles may be obtained by the passage of the suspension under a corona generated by a wire at a positive potential of approximately 4,500 V, which induces a positive charge onto the particles.

After transfer of an adequate amount of liquid toner from the development roll 130 onto the imaging roll 140, some liquid toner remains present on the surface of the former. This remaining fraction of liquid toner must be removed to avoid visual interference with images to be printed subsequently.

The present disclosure is based inter alia on the insight of the inventors that the compactification, as for instance obtained by the application of an electric field, renders the mechanical removal of unused liquid toner from the development member less efficient. In particular, the inventors have found that a residue of coagulated imaging particles tends to stick to the surface of the development roll 130, and resists removal by the known methods of scraping and brushing.

Embodiments of the present disclosure achieve improved removal of the excess toner from the development member by providing an oscillating electric field source arranged to substantially decompactify said chargeable imaging particles prior to or during mechanical removal. “Prior to” is to be understood as meaning that individual charged particles undergo the force effect of the applied oscillating electric field before they are contacted by a mechanical removal member (such as a blade, a brush, or a roller). Nevertheless, both the electrical field source and the mechanical removal means operate simultaneously (or even permanently), such that electrical decompactification and mechanical toner removal can be seen to take place simultaneously in the apparatus.

The oscillating electric field source may be an elongate electrode arranged parallel to and in proximity of the development member. It may in particular be a wire or plate-shaped electrode that is integrated in the mechanical removal means; where the mechanical removal means is a part moulded from a resin, the electrode may be an overmoulded metallic part (plate, wire) inside the mechanical removal means.

The electrical and mechanical “loosening up” of the toner particles may be advantageously combined by providing at least one electrode that is integrated in a mechanical removal means that has the shape of a wiper 133 (e.g. an elastomer blade) or a comb, arranged to be at least partially immersed in the liquid adhering to the development roll. The wiper shaped blade or blades 133 are advantageously polished to a high degree of precision (less than 1 μm) and may be positioned one after another. Additionally, a cleaning brush roller (not illustrated) with very fine bristles may be placed between or next to the one or more electrodes to mechanically break up toner particle aggregates that may be formed as a result of physical and electrophoretic compaction during development and action of the leading cleaner blade.

The use of a bias voltage has the advantage that the freely suspended toner particles can be made to drift towards the intended evacuation zone under the influence of the average electric field.

The electrical field is preferably generated by applying a bias voltage in the range of −300 V to −100 V to the electrode, with an additional oscillating component having an amplitude in the range of 4000 V rms to 5000 V rms. The oscillating component preferably has a frequency in the range of 0.5 kHz to 5 kHz.

The cited bias voltage range is particularly appropriate for a development member with an operating tension of approximately 400-600 V. Different values may be chosen for the bias voltage of the electrical field in situations where the development member operates at a different voltage.

The combined voltage applied to the electrode must be kept below the level at which a corona effect might occur, because the occurrence of a corona effect may lead to the production of ozone around the electrode, which may be undesirable from an environmental or regulatory point of view.

The removed unused toner may be recycled to a toner supply or to a recycling and replenishment system, including optional recirculation to the liquid toner reservoir 110. Likewise, any excess carrier liquid scraped off by the carrier liquid removal means 142, 152 may be recycled and/or recirculated to the liquid toner reservoir 110. If recirculation is applied, care must be taken not to cause undue dilution or concentration of the liquid toner. This may be achieved by initially collecting recirculated carrier liquid separately, and adding it to the reservoir that receives the recirculated liquid toner in function of a measured or calculated toner concentration of the liquid therein, so as to obtain a concentration in the desired range.

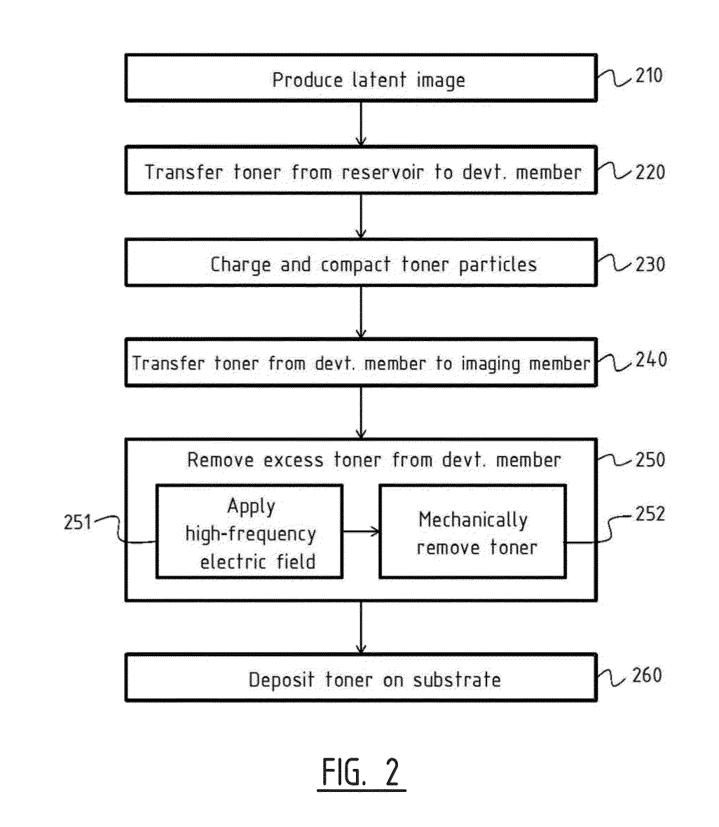

A digital printing process according to the present disclosure will now be described in connection with FIG. 2. It will be understood that all features described in more detail in connection with the apparatus of FIG. 1, apply also to the process according to the disclosure, with the same technical effects and advantages. Hence, these features and their operation will not be repeated in detail hereinbelow.

Accordingly, embodiments of the present disclosure also relate to a digital printing process using liquid toner, the liquid toner comprising chargeable imaging particles and a carrier liquid, the method comprising: producing 210 a latent image as a pattern of electric charge on an imaging member; transferring 220 a quantity of liquid toner from a reservoir onto a development member; compacting 230 the chargeable imaging particles in the quantity of liquid toner by applying an electric field; developing the latent image by transferring 240 a portion of the quantity of liquid toner onto the imaging member in accordance with the pattern after the charging and compacting, whereby the developing leaves a remaining fraction of the quantity of liquid toner on the development member; removing 250 the remaining fraction from the development member (after the transferring of the portion); and depositing 260 the portion (i.e., the developed image) onto a printing substrate; wherein the removing 250 of the remaining fraction comprises mechanically removing 252 the electrically decompactified liquid toner from the development member; and wherein the removing 250 of the remaining fraction further comprises applying 251 an oscillating electric field to the remaining fraction so as to substantially decompactify the chargeable imaging particles prior to or during the mechanical removal 252.

The charging of the toner particles may take place substantially simultaneously with the compacting step 230, by virtue of the same electrical field or corona. Alternatively or additionally, the toner particles may be charged in advance while still in the container (“charging in the bottle”).

In a final image fixing stage (not illustrated), the image on the substrate is fixed. Preferably the image fixing stage uses heat and compression between rollers. Alternatively, the image fixing stage uses non-contact methods such as IR, UV and EB curing or other known methods of image fusing.

FIG. 3 presents a more detailed illustration of an exemplary toner supply and removal arrangement.

In particular, the feeding mechanism that provides liquid toner to the development member is shown in more detail: a pump comprising a set of gears 115 provides liquid to a first member 116, which in turn feeds the toner supply member 120. The latter is equipped with a doctoring blade 121 to provide a standardized amount of toner to the development member 130. An electrical field or corona is generated by electrode 131 in order to charge (if necessary) the toner particles, and compactify them. After the development of the latent image at the imaging member (not shown in FIG. 3), the toner mass is decompactified by the electrode integrated in blade 133 and mechanically removed by the blade.

Throughout the application, the various stages off the printing system have been described as members. In specific cases, these members have been described and/or illustrated as rollers. The skilled person will appreciate that the same principles may be applied with suitably designed belts.

Additionally, while the disclosure has been described hereinabove in connection with a single imaging stage (single-color printing), it will be appreciated by a person skilled in the art that the relevant parts of the disclosure can be replicated several times to allow for multi-color printing.

Particular advantages of the disclosure have been described in connection with the removal of liquid toner from the development member 130. It will be appreciated by the skilled person that the approach of the disclosure may be applied to other stages of the printing process at which liquid toner needs to be removed from a toner-carrying member. In particular, the disclosure also envisions the use of the device described in connection with FIG. 3 for removal of liquid toner from imaging member 140 at the toner removal device 146, and from the intermediate transfer member 150 at the liquid toner removal device 153.

FIG. 4 illustrates a roller 400 of a digital printing apparatus. The roller 400 is arranged to receive a quantity of liquid toner. In operation, the roller 400 rotates in a direction indicated by an arrow in FIG. 4. The roller 400 is provided with excess removal means comprising a scraper 402 and a discharge blade 401 with integrated electrode 410. Both the discharge blade 401 and the scraper 402 run in contact with the roller 400. The discharge blade 401 is manufactured and mounted in such a way that the discharge blade contacts the roller surface over a surface with a length l. The electrode 410 is embedded in electrically insulating material 411 of the discharge blade 401. At an end part of the discharge blade 401 there may be provided a terminal 412 for applying a voltage on the electrode 410. The electrode 410 comprises an electrode surface opposite to the surface of the roller 400 extending over a length l substantially parallel to the roller surface. The length l is preferably larger than 5 mm, more preferably larger than 10 mm, e.g. approximately 15 mm. In that way it can be guaranteed that the liquid toner is subjected to a sufficient number of alternations of the AC field while passing the electrode 410, so that a good decompacting of the imaging particles in the liquid toner is obtained. The electrically insulating material 411 of the discharge blade 401 may e.g. be a polyurethane material. The distance d between the electrode and the surface of the discharge blade contacting the roller 400 is preferably smaller than 1000 μm, more preferably smaller than 500 μm, and may be as small as 5 μm.

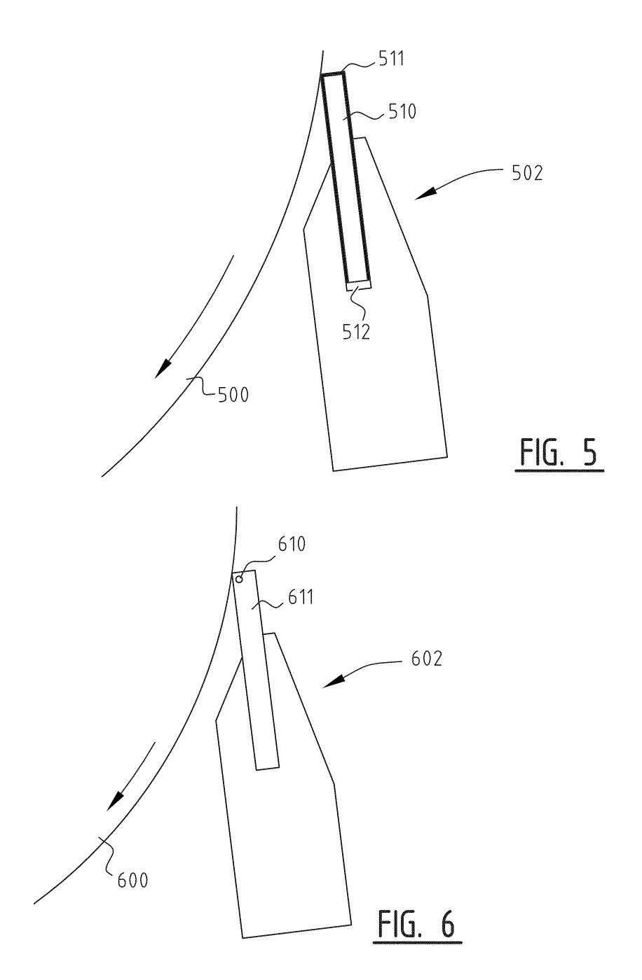

FIG. 5 illustrates another variant of the disclosure comprising a roller 500 and a scraper 502 with an integrated electrode 510. In this embodiment, the electrode 510 is preferably manufactured of an electrically conducting plastic material. Electrode 510 is provided with an electrically insulating overcoating layer 511. Further, a terminal 512 is provided for connection with an AC source. The thickness of the overcoating layer 511 may e.g. be smaller than 1000 μm, more preferably smaller than 500 μm, and may be as small as 5 μm.

FIG. 6 illustrates a further embodiment comprising a roller 600 and a scraper 602 with an integrated wire electrode 610. Although in the illustrated embodiment, the scraper 602 comprises one wire electrode 610, the skilled person understands that also a plurality of wire electrodes could be provided. The wire electrode 610 is embedded in electrically insulating material 611 forming the blade of the scraper 602.

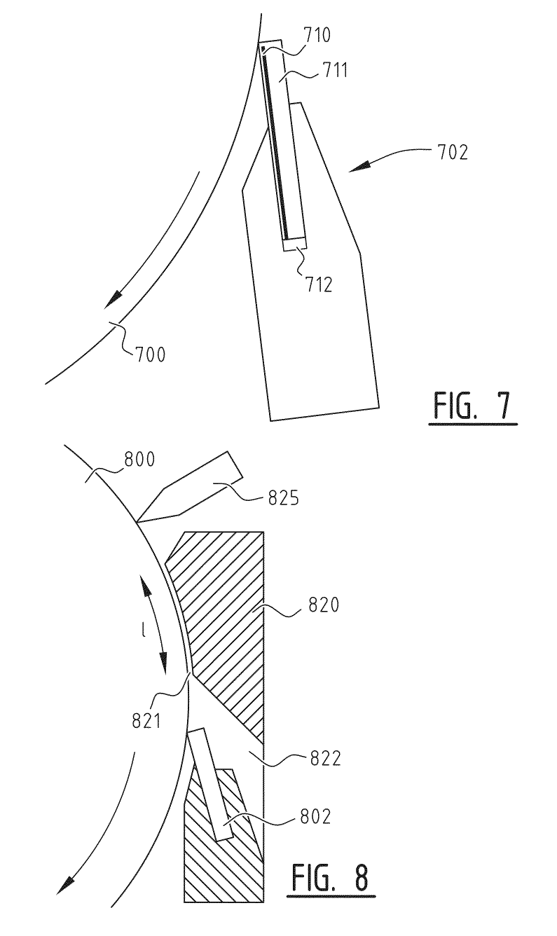

The embodiment of FIG. 7 is similar to the embodiment of FIG. 6, with a difference in that the wire electrode is replaced with a plate electrode 710. The plate electrode 710 is embedded in an electrically insulating material 711 forming the blade of the scraper 702. A terminal 712 is provided for applying an AC voltage on the electrode 710. As in the previous embodiments, the distance between the electrode 710 and the roller surface 700 is preferably smaller than 500 μm.

According to variants of the embodiments of FIGS. 5-7, the scraper and electrode could be given a different shape, e.g. in order to increase the number of alternations that the liquid toner is subjected to before being scraped off by the scraper.

FIG. 8 illustrates yet another embodiment comprising a roller 800 and excess removal means comprising a scraper 802, an electrode 820, and a liquid injection means 825. The electrode 820 and the scraper 802 may be part of a single integrated structure or may be separate parts. The electrode 820 has an electrode surface extending parallel to the roller surface over a length l, seen in the direction of rotation of the roller 800. As in the embodiment of FIG. 4, the length l is preferably such that the liquid toner is subjected to a sufficient number of alternations of the AC voltage applied on the electrode 820. By having the electrode surface extending parallel to the roller surface, a channel 821 is created. In order to further facilitate the decompacting of the liquid carrier layer, a liquid may be injected in the channel 821, using the liquid injection means 825. Depending on where in the apparatus or process the removal means are active, the injected liquid may be different. For removal means on a developer member the injected liquid may be e.g. toner liquid, but for members downstream of the developer member the injected liquid could also be carrier liquid without imaging particles.

While the disclosure has been described hereinabove with reference to embodiments using positively charged toner particles and electric tensions or fields arranged to act on these positively charged toner particles, in particular to electrophoretically move them, a skilled person will immediately appreciate that the disclosure equally applies to embodiments using negatively charged toner particles. In the latter case, the polarity of the electric fields acting on the toner particles needs to be reversed, leading to a physically equivalent arrangement with the same technical effects. All voltage ranges mentioned in the present description with respect to embodiments operating with positively charged toner particles are hereby stated to also apply to corresponding embodiments operating with negatively charged toner particles, provided that the sign of the voltage values is changed.

While the disclosure has been described hereinabove with reference to specific embodiments, this is done to illustrate and not to limit the disclosure. The skilled person will appreciate that other ways of implementing the inventive concept described herein are within the scope of the disclosure, as defined by the accompanying claims.

What is claimed is:

1. A digital printing apparatus using liquid toner comprising chargeable imaging particles and a carrier liquid, the apparatus comprising:
a first member arranged to receive and transport a quantity of liquid toner;
excess removal means arranged to remove liquid toner containing charged particles from said first member;
said excess removal means comprising mechanical removal means for mechanically removing said liquid toner from said first member, and a source for generating an AC electric field in the liquid toner containing charged particles, wherein the source comprises a stationary electrode placed in proximity of the first member, said source with electrode being arranged to substantially decompactify said chargeable imaging particles prior to or during said mechanical removal.

2. The digital printing apparatus of claim 1, wherein the electrode is integrated in the mechanical removal means.

3. The digital printing apparatus of claim 1, wherein the excess removal means comprise a scraper in contact with the first member, and wherein the electrode is integrated in the scraper.

4. The digital printing apparatus of claim 1, wherein the electrode is any one of the following:
at least one wire, a plate, or a combination thereof.

5. The digital printing apparatus of claim 1, wherein the electrode is surrounded by electrically insulating material, such that a layer of electrically insulating material extends between a surface of the first member and the electrode.

6. The digital printing apparatus of claim 1, wherein the excess removal means comprise a discharge blade in contact with the first member, and the electrode is integrated in the discharge blade.

7. The digital printing apparatus of claim 1, wherein the electrode is located at a distance between 5 and 1000 μm from the surface of the first member.

8. The digital printing apparatus of claim 1, the stationary electrode is arranged opposite to a surface of the first member, such that a channel for liquid toner is created between the electrode and the first member.

9. The digital printing apparatus of claim 8, wherein the excess removal means further comprise liquid injection means configured for injecting liquid in the channel.

10. The digital printing apparatus of claim 1, wherein the electrode has an electrode surface opposite to a surface of the first member, and wherein said electrode surface extends substantially parallel to the surface of the first member, preferably over a length l, seen in the direction of transport, which is larger than 5 mm, more preferably larger than 10 mm.

11. The digital printing apparatus of claim 1, wherein the first member is a rotating roller.

12. The digital printing apparatus of claim 1, wherein said first member is configured to transfer a portion of said quantity of liquid toner onto a second member in contact with the first member, leaving a remaining fraction of said quantity of liquid toner on the first member;
wherein said excess removal means is arranged to remove said remaining fraction.

13. The digital printing apparatus of claim 12, wherein the second member is an imaging member adapted to sustain a pattern of electric charge forming a latent image on its surface;
wherein the first member is a development member arranged to receive a quantity of liquid toner from a reservoir, and to develop said latent image by transferring a portion of said quantity of liquid toner onto said imaging member in accordance with said pattern, said developing leaving a remaining fraction of said quantity of liquid toner on the development member;
said digital printing apparatus further comprising:
an electrical field generating means adapted to compact said chargeable imaging particles in said quantity of liquid toner by applying an electric field prior to its transfer onto the imaging member.

14. The apparatus of claim 13, wherein said electrical field generating means is further adapted to charge said chargeable imaging particles in said quantity of liquid toner.

15. The apparatus of claim 13, wherein said excess removing means comprises a sheet or comb shaped member including the electrode, said member being arranged to be at least partly immersed in said liquid toner adhering to said development member.

16. The apparatus of claim 1, further comprising biasing means setting a DC bias between the first member and the electrode having an absolute value between 0 and 1000 V, wherein said source for generating an AC electric field is configured for applying an AC voltage on the electrode having any one or more of the following properties:
an oscillating component with an amplitude in the range of 500 V rms to 5000 V rms;
a frequency in the range of 0.5 kHz to 5 kHz.

17. A digital printing process using liquid toner, said liquid toner comprising chargeable imaging particles and a carrier liquid, said method comprising:
producing a latent image as a pattern of electric charge on an imaging member;
transferring a quantity of liquid toner from a reservoir onto a development member;
compacting said chargeable imaging particles in said quantity of liquid toner by applying an electric field;
developing said latent image by transferring a portion of said quantity of liquid toner onto said imaging member in accordance with said pattern after said charging and compacting, said developing leaving a remaining fraction of said quantity of liquid toner on the development member;
removing said remaining fraction from said development member; and
depositing said portion onto a printing substrate;
wherein said removing of said remaining fraction comprises mechanically removing said liquid toner from said development member using excess removal means;
wherein said removing of said remaining fraction further comprises applying an oscillating electric field to said remaining fraction so as to substantially decompactify said chargeable imaging particles prior to or during said mechanical removal, using means for generating said oscillating electric field that are integrated in said excess removal means.

18. The process of claim 17, wherein said applying of said electrical field comprises charging an electrode in proximity of said development member with a bias voltage in the range of −300 V to −100 V.

19. The process of claim 17, wherein said applying of said electrical field comprises charging an electrode in proximity of said development member with an oscillating component with an amplitude in the range of 4000 V to 5000 V.

20. The process of claims 17, wherein said electrical field has a frequency in the range of 0.5 kHz to 5 kHz.
